(19) United States
(12) Patent Application Publication
(10) Pub. No.: US 2003/0186149 A1
(43) Pub. Date: Oct. 2, 2003

(54) Developer, cartridge holding developer, and image forming apparatus

(76) Inventors: Toru Ishihara, Tokyo (JP); Kenji Koido, Tokyo (JP)

Correspondence Address: RABIN & CHAMPAGNE, PC, 1101 14TH STREET, NW, SUITE 500, WASHINGTON, DC, 20005, US

(21) Appl. No.: 10/354,049

(22) Filed: Jan. 30, 2003

(30) Foreign Application Priority Data
Mar. 29, 2002 (JP) 2002-096883

(51) Int. Cl. G03G 9/08

(52) U.S. Cl. 430/108.1; 430/108.7; 430/108.3; 430/108.22

(57) ABSTRACT

A developer includes developer main particles and abrasive particles added to the developer main particles. The developer main particles include at least a resin material and a coloring material. The abrasive particles and the developer main particles are opposite in polarity when they are charged. The abrasive particles have an average diameter in the range of 50 to 5000 nm and preferably in the range of 150 to 2000 nm. A fluidity-adding agent is added to the developer main particles. The fluidity-adding agent has a diameter in the range of 5 to 40 nm. The fluidity-adding agent is at least 0.1 weight parts with respect to the developer main particles, and the abrasive particles are in the range of 0.02 to 1.2 weight parts.

### BACKGROUND OF THE INVENTION

1. FIELD OF THE INVENTION

The present invention relates to a developer, a cartridge that holds the developer therein, and an image forming apparatus into which the cartridge is attached.

2. DESCRIPTION OF THE RELATED ART

Conventional electrophotographic image forming apparatus include a printer, a copying machine, a facsimile machine, and a composite apparatus of these. A charging roller charges the surface of a photoconductive drum uniformly. A developing unit applies toner to an electrostatic latent image formed on the photoconductive drum to develop the electrostatic latent image into a toner image. Then, the toner image is transferred onto a print medium by a transfer roller. The print medium is advanced to a fixing unit where the toner image on the print medium is fused into a permanent image.

In order to ensure adequate fixing performance, the toner is required to be easy to melt, i.e., “sharp melt”. Especially when a color image forming apparatus is to print on a transparency, in order to obtain good coloring property, toner is required to provide good transmissivity and be easier to melt than a monochrome toner. A high speed, small size monochrome printer requires soft, easy to melt toner so that the toner image can be fused at low temperature.

In order to implement a toner easy to melt, a mold release agent may be added to resin particles (referred to as developer main particles hereinafter) that constitutes the toner. Many of the mold release agents are easier to melt than the developer main particle. Mold release agents include synthetic waxes such as polyethylene and polypropylene or natural wax such as carnauba wax. These waxes are added alone or in combination. Softners such as fatty acid ester are also known to have as good mold release effect 7 as the waxes and may be used sometimes.

In order to provide toner of low viscosity and high fluidity, a fluidity-adding agent is often added to the developer main particles. Fluidity-adding agents include oxidized silicon (referred to as silica hereinafter); surface treated products of silica, titanium, oxidized titanium; surface treated products of titanium, clay; inorganic abrasives such as alumina, calcium carbonate; and organic abrasives such as methacrylate abrasives, melamine abrasives, and silicone abrasives.

The particle diameter of the fluidity-adding agent is selected to be smaller than that of the developer main particle. The fluidity-adding agent is added to the surfaces of developer main particles during a manufacturing stage of toner by using a Henschel mixer, thereby producing as a final product of toner.

With the aforementioned conventional image forming apparatus, fusing performance of a fixing unit can be improved by using a toner that is easy to melt, adding a mold release agent to the developer main particles to make the toner easy to melt, and adding a fluidity-adding agent to the toner. However, improving the fusing performance by doing so also causes the developer toner to cling to the background of the latent image formed on the photoconductive drum, leading to soiling of the surface of the photoconductive drum and hence poor print quality.

The inventors conducted an endurance printing test for an image forming apparatus having a one-component development type developing unit that does not use a carrier as a medium for carrying toner and an image forming apparatus having a two-component development type developing unit that uses a carrier. Then, the surfaces of charged members such as the developing roller, toner supplying roller, developing blade, and carrier are observed under an electron microscope (SEM, scanning electron microscope). The surfaces were covered uniformly by only slightly melted toner, resulting in “filming”. When infrared spectroscopy was performed on the surface of the charged members, C—H stretching vibration indicative of the existence of toner near a wave number of 1720 cm⁻¹ and C═O stretching vibration indicative of the existence of toner near a wave number of 1720 cm⁻¹ were observed. The surfaces were cleaned with, for example, alcohol, and then printing was performed. The result is that no soiling of the print medium was observed and print quality was excellent.

As described above, the occurrence of filming on the surfaces of the charged members causes the toner particles to rub each other to be charged triboelectrically. This results in insufficient charging of toner particles or causes the toner particles to be charged to an opposite polarity. As a result, the developer toner clings to the background of the latent image formed on the photoconductive drum, leading to soiling of the surface of the photoconductive drum.

### SUMMARY OF THE INVENTION

The present invention was made to solve drawbacks of the aforementioned conventional developer.

An object of the invention is to provide a developer, a cartridge for holding the developer therein, and an image forming apparatus. The image forming apparatus is capable of preventing the developer toner from clinging to the background of the latent image formed on the photoconductive drum, the toner clinging to the photoconductive drum leading to soiling of the surface of the photoconductive drum, and improve print quality.

A developer includes developer main particles and abrasive particles added to the developer main particles. The developer main particles include at least a resin material and a coloring material. The abrasive particles and the developer main particles are opposite in polarity to which they are charged.

The abrasive particles have an average diameter in the range of 50 to 5000 nm.

The average diameter of the abrasive particles is preferably in the range of 150 to 2000 nm.

A fluidity-adding agent is added to the developer main particles.

The fluidity-adding agent is one of a plurality of fluidity-adding agents, and has a diameter in the range of 5 to 40 nm.

The developer main particles are charged to a first polarity when the developer main particles are subjected to frictional contact with iron powder. The abrasive particles are charged to a second polarity opposite to the first polarity when the abrasive particles are subjected to frictional contact with iron powder.

The fluidity-adding agent is at least 0.1 weight parts with respect to the developer main particles, and the abrasive particles are in the range of 0.02 to 1.2 weight parts.

The abrasive particles are preferably in the range of 0.05 to 1.0 weight parts.

A developer cartridge holds a developer therein that includes developer main particles and abrasive particles. The developer main particles include at least a resin material and a coloring material. The abrasive particles are added to the developer main particles. The abrasive particles and the developer main particles are opposite in polarity to which they are charged.

An image forming apparatus includes a developer cartridge, an image bearing body (e.g., photoconductive drum), a charging unit, an exposing unit, and a developing unit. The developer cartridge holds a developer therein. The charging unit charges the surface of the image bearing body. The exposing unit illuminates the surface of the image bearing body charged by the charging unit to form an electrostatic latent image. The developing unit develops the electrostatic latent image with a developer supplied from the developer cartridge into a visible image. The developer includes developer main particles including at least a resin material and a coloring material, and abrasive particles added to the developer main particles. The abrasive particles and the developer main particles are opposite in polarity to when they are charged.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

FIG. 1 is an illustrative diagram, showing a first example of an electrophotographic image forming apparatus according to an embodiment of the invention;

FIG. 2 is a cross-sectional view of a developer cartridge according to the embodiment; and

FIG. 3 illustrates an outline of an electrophotographic image forming apparatus according to the embodiment of the invention.

### DETAILED DESCRIPTION OF THE INVENTION

The present invention will be described in detail with reference to the accompanying drawings.

{One-Component Development Type Developing Unit}

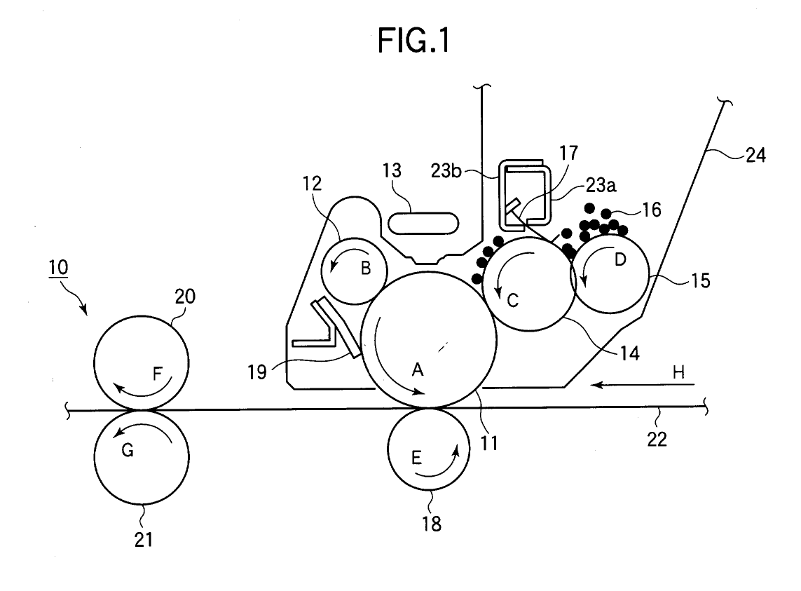

FIG. 1 is an illustrative diagram, showing a first example of an electrophotographic image forming apparatus according to an embodiment of the invention.

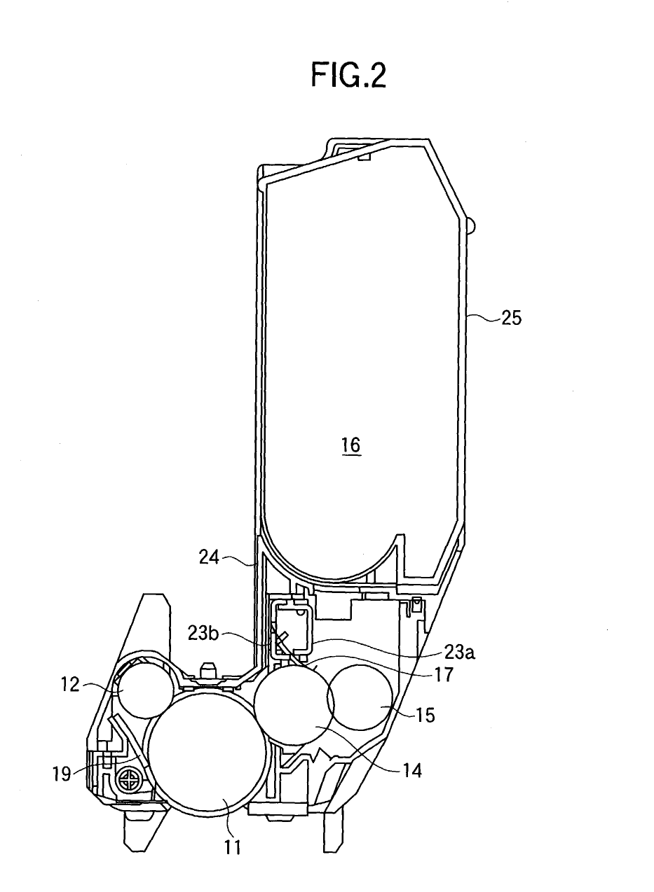

FIG. 2 is a cross-sectional view of a developer cartridge according to the embodiment.

Referring to FIG. 1, a photoconductive drum 11 is driven in rotation in a direction shown by arrow A. A charging roller 12 receives a voltage from a power supply, not shown, and rotates in contact with the photoconductive drum in a direction shown by arrow B. A non-contact type charging unit such as scorotron and corotron may be used in place of the charging roller.

An LED head 13 illuminates the charged surface of the photoconductive drum 11. A laser may be used in place of the LED head 13. A developing roller 14 rotates in contact with or not in contact with the photoconductive drum 11 in a direction shown by arrow C. The developing roller 14 delivers the toner to a developing area so that the toner is deposited to the electrostatic latent image to develop the electrostatic latent image into a visible toner image. A toner supplying roller 15 rotates in contact with or not in contact with the developing roller 14 in a direction shown by arrow D. The toner-supplying roller 15 supplies toner 16 to the developing roller 14. A developing blade 17 forms a thin layer of toner 16 on the surface of the developing roller 14. The developing roller 14, toner-supplying roller 15, and developing blade 17 form a developing unit.

A transfer roller 18 rotates in contact with the photoconductive drum 11 in a direction shown by arrow E. The transfer roller 18 receives a voltage from a power supply, not shown, to transfer the toner image from the photoconductive drum 11 onto a print medium 22 such as print paper and transparency. A non-contact type corotron transfer unit may be used in place of the transfer roller 18. A cleaning unit 19 removes the residual toner 16 on the photoconductive drum 11 after transferring the toner image onto the print medium 22. The cleaning unit according to the embodiment takes the form of a blade cleaning type cleaning unit in which a rubber blade is in contact with the photoconductive drum 11. Instead of the rubber blade type cleaning unit, a roller type cleaning unit or a brush type cleaning unit may be used.

A fixing unit 10 fuses the toner image transferred on the print medium 22 into a permanent image. The fixing unit 10 includes a heat roller 20 and a pressure roller 21. The surface of the heat roller 20 is heated by a heat generating element, not shown, and heats the toner 16 on the print medium 22. The pressure roller 21 is in pressure contact with the heat roller so that the fused toner is pressed against the print medium 22. In the present embodiment, the fixing unit 10 is of a roller type. The fixing unit may be of other types such as a belt type that uses a belt, a film type that uses a film, and a flash type that utilizes light energy. The roller type and belt type may be an oil-replenishing type fixing unit equipped with an oil replenishing mechanism such as an oil replenishing roller, oil replenishing sheet, or oil tank, thereby reliably preventing “hot-offset”. The oil can be of any type but those having relatively low viscosity such as silicone oil and mineral oil are commonly used. Still alternatively, an oil-less fixing unit may be employed to prevent “hot-offset”.

Reference numerals 23a, 23b, and 24 denote a blade stopper, a blade holder, and an ID unit, respectively. Reference numeral 25 denotes a toner cartridge that holds toner 16 therein.

{Two-Component Type Developing Unit}

An image forming apparatus having a two-component type developing unit will be described.

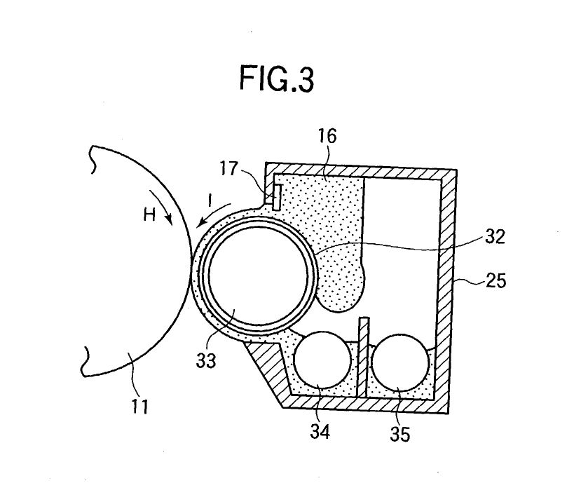

FIG. 3 illustrates an outline of an electrophotographic image forming apparatus according to the embodiment of the invention. Referring to FIG. 3, a photoconductive drum 11 rotates in a direction shown by arrow H and a developing sleeve 33 rotates in a direction shown by arrow I. The developing sleeve 33 delivers a non-magnetic toner by means of a magnetic carrier to the photoconductive drum 11. Reference numerals 17 and 25 denote a developing blade, and a toner cartridge, respectively. A magnet roller 33 is stationary and serves as a magnetic field generator. Reference numerals 34 and 35 denote toner-conveying screws.

With the previously described one-component type development, filming may result if an easy-to-melt toner 16 is used, a mold release agent is added to the developer main particles to prompt quick melting, or a fluidity-adding agent is added to the developer main particles to improve fluidity. The filming causes the developer toner 16 to cling to the background of the latent image formed on the photoconductive drum 11, leading to soiling of the surface of the photoconductive drum 11 and hence poor print quality.

Printing was performed for different types of toner having various types of fine particles added and print quality was evaluated. The printing revealed that adding abrasives that become charged to a polarity opposite to the developer main particles is effective. In the present specification, the polarity of charge of the samples of developer main particles and abrasives is determined depending on the polarity to which the sample particles are charged when the samples are subjected to frictional contact with iron powder. Here, it should be noted that iron powder is not a constituent of the samples but merely a reference when the polarity of charge of the samples is discussed. The polarity of charge of a sample is said to be “positive” if the friction between iron powder and the sample particles causes the sample particles to be triboelectrically charged positively. The polarity of charge of a sample is said to be “negative” if the friction between iron powder and the sample particles causes the sample particles to be triboelectrically charged negatively.

In order for abrasives to have sufficient polishing effect, the diameter of the abrasive particles plays an important role. The average diameter of an abrasive is in the range of 50 to 5000 nm, and preferably in the range of 100 to 2000 nm. For example, silica and oxidized titanium as a fluidity-adding agent have an average particle diameter in the range of 5 to 40 nm, and therefore exhibit no good polishing effect.

If the developer main particle becomes charged negatively, then melamine abrasive, for example, is useful as an abrasive that becomes charged positively. If the developer main particle becomes charged positively, then silicone abrasive, for example, is useful as an abrasive that becomes charged negatively. These abrasives can minimize the soiling of the surface of the photoconductive drum due to filming, improving the print quality.

In the present invention, melamine abrasive and formaldehyde undergo addition polymerization at a selected temperature and for a selected length of time to produce an abrasive having an average diameter in the range of 0.05 to 6.5 μm. The thus produced abrasive is added to the developer main particles. Printing was performed by using this toner and a one-component development type developing unit. After printing, the surface of the developing blade 17 in contact with the developing roller 14 was observed under an electron microscope (SEM) and subjected to infrared absorption spectrometry, which revealed that a large number of abrasive particles were deposited on the surface. This is considered due to the following mechanism. When the developing blade 17 forms a layer of toner on the surface of the developing roller 14, stress is developed to cause part of the abrasive to come off the developer main particles, and cling to the developing blade, resulting in filming. The particles of abrasive were also deposited on the surfaces of the developing roller 14 and the toner-supplying roller 15.

The abrasive is considered to function just like the carrier in the two-component development type developing unit. Therefore, the use of additives that become charged to a polarity opposite to the developer main particles is desirable.

It is not desirable to use abrasives such as silica, which has an average particle diameter in the range of 5 to 40 nm, as an abrasive that become charged opposite in polarity to the developer main particles. This is because silica and the developer main particles attract each other by not only the Coulomb force but also Vander Waals forces. If particles have diameters on the order of nano-millimeters, Vander Waals forces become prominent.

Vander Waals forces increase in direct proportion to the particle diameter, while Coulomb force increases in proportion to the square of the particle diameter. Thus, the smaller the particle diameter becomes, the larger the Vander Waals forces become.

In fact, printing was performed using a toner that silica particles having an average diameter of 12 nm is added to the developing main particles. Filming was more serious when negatively charged silica is added to positively charged developer main particles than when positively charged silica is added to negatively charged developer main particles. However, positively charged silica particles having an average diameter of 300 nm did not result in any soiling of the surface of the photoconductive drum. Conversely, negatively charged silica particles having an average diameter of 300 nm did result in soiling of the surface of the photoconductive drum over a large area.

Adding abrasives to the developer main particles is more effective in minimizing the soiling of the surface of the photoconductive drum when a one-component development is used than when a two-component development is used. The one-component development type developing unit includes a contact type developing unit and a non-contact type developing unit. The contact type developing unit is more effective in minimizing the soiling of the photoconductive drum when the contact type developing unit is used than when the non-contact type developing unit is used. This fact reveals that adding abrasives to the developer main particles is more effective in minimizing the soiling of the surface of the photoconductive drum when printing is performed using a developing unit of a type where a large stress is exerted on the toner 16.

Various parameters are involved in forming a toner layer on the developing roller 14. When such parameters as pressure applied to the developing roller 14 by the developing blade 17 and pressure applied to the developing roller 14 by the toner supplying roller 15 are large, more abrasive is deposited on the surface of the charged members of the developing unit.

The toner according to the present invention will be described by way of examples and comparisons. An amount of charge represents blow-off charge. The carrier was TEFV200 available from POWDERTECH. The carrier and resin were mixed so that the toner 16 represents 10% and then the mixture was placed in a polyethylene bottle of 100 ml capacity. Then, a sample was prepared by agitating the mixture at a speed of 60 rpm for 10 minutes. Then, 0.2 grams of the sample was weighed and blew at air pressure of 0.2 kgf/cm² for 180 seconds and then an amount of charged on the surface of the sample.

### EXAMPLES

Examples 1-5 and comparisons 1-2 will be described with reference to Table 1.

TABLE 1

| | melamine abrasive | soiling of surface of |
|---|---|---|
| | added (weight parts) | photoconductive drum |
| Example 1 | 0.02 | fair |
| Example 2 | 0.05 | good |
| Example 3 | 0.50 | good |
| Example 4 | 1.00 | good |
| Example 5 | 1.20 | fair |
| Comparison 1 | 0 | poor |
| Comparison 2 | 1.50 | poor |

### Example 1

The following materials were placed in a Henschel mixer: 100 weight parts of polyester (number average molecular weight Mn=3700, glass transition temperature Tg=62° C.) and 4.5 weight parts of phthalocyanine blue as a coloring agent, and 2.5 weight parts of charge controlling agent (negative charge). The mixture in the Henschel mixer was sufficiently agitated and kneaded. Then, the material was heated to melt using a roll mill at a temperature of 120° C. for 3 hours, and then cooled to room temperature. Then, the kneaded material was crushed by using a dispersion separator (available from NIPPON PNEUMATIC MFG., CO. LTD) and classified to obtain developer main particles having an average diameter of 8 μm. The average amount of charge of the developer main particles was −50 μC/g.

Then, silica that contains 0.5 weight parts of R972 (Aerosil Japan), 0.5 weight parts of RX50 (Aerosil Japan) and 0.02 weight parts of melamine abrasive M-300 having an average diameter of 300 nm and an average amount of charge of +600 μC/g were added to the developer main particles, thereby obtaining a final toner.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. However, some soiling appeared on the print medium 22. Printing was performed with a sufficient density. No filming occurred on the surface of the charged members and no abnormality was observed in print result.

### Example 2

Toner was manufactured in much the same way as Example 1 except that 0.05 weight parts of melamine abrasive M-300 was added to the developer main particles.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. No soiling appeared on the print medium 22. Printing was performed with a sufficient density. No filming occurred on the surface of the charged members and no abnormality was observed in the print result.

### Example 3

Toner was manufactured in much the same way as Example 1 except that 0.5 weight parts of melamine abrasive M-300 was added to the developer main particles.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. No soiling appeared on the print medium 22. Printing was performed with a sufficient density. No filming occurred on the surface of the charged members and no abnormality was observed in print result.

Then, the developing unit was disassembled and a surface area of the developing blade 17 in contact with the developing roller 14 was observed under an electron microscope (SEM). A large number of particles larger than silica having an average diameter of about 300 nm were observed. Infrared absorption spectrometry showed a peak value that implies the presence of melamine.

Likewise, the surfaces of the developing roller 14 and toner supplying roller 15 were observed under an electron microscope (SEM) and the presence of melamine abrasive was observed. This reveals that during the endurance printing test, part of the melamine abrasive came off the toner particles and was deposited on the surfaces of the charged members. After the endurance printing test, the amount of charge on the toner deposited on the surface of the charged members was measured by using analyzer E-SPART available from HOSOKAWAMICRON CORPORATION. The average amount of charge was −25 μC/g, a minimum amount of charge was −35 μC/g, and a maximum amount of charge was −18 μC/g.

### Example 4

Toner was manufactured in much the same way as Example 1 except that 1.00 weight parts of melamine abrasive M-300 was added to the developer main particles.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. No soiling appeared on the print medium 22. Printing was performed with a sufficient density. No filming occurred on the surface of the charged members and no abnormality was observed in print result.

### Example 5

Toner was manufactured in much the same way as Example 1 except that 1.20 weight parts of melamine abrasive M-300 was added to the developer main particles.

Using the thus obtained toner an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. Some soiling appeared on the print medium 22. Printing was performed with a sufficient density. No filming occurred on the surface of the charged members and no abnormality was observed in print result.

Comparison 1

Toner was manufactured in much the same way as the Example 1 except that melamine abrasive M-300 was not added to the developer main particles.

Using the thus obtained toner, an endurance printing test was conducted for an image forming apparatus in FIG. 1 by continuously printing a solid image (print duty is 100%) on A4 size print medium 22.

For first pages, printing can be performed with excellent print quality and good print quality was maintained until 5000 pages have been printed. After printing 5000 pages, soiling of the print medium began to be noticeable. After printing 30000 pages, the soiling of the print medium became very prominent.

Then, the developing unit was disassembled and a surface area of the developing blade 17 in contact with the developing roller 14 was observed under an electron microscope (SEM). Extremely thin filming was observed. Infrared absorption spectrometry showed CH stretching vibration that indicates the presence of toner near a wave number of 28000 cm⁻¹ and C═O stretching vibration that indicates the presence of toner near a wave number of 1720 cm⁻¹.

Likewise, filming was also observed on the surfaces of the developing roller 14 and the toner-supplying roller 15.

The reason why soiling increases gradually during an endurance printing test is that toner is deposited on the surfaces of the charged members to cause filming so that a phenomenon similar to the self charging due to friction between toner particles occurs.

After the endurance printing test of the comparison 1, the amount of charge of the toner remaining on the developing roller 14 was measured using analyzer E-SPART from HOSOKAWAMICRON. An average amount of charge was −10 μC/g, a minimum amount of charge was −15 μC/g, and a maximum amount of charge was +10 μC/g. The measurement of the amount of charge reveals that development of toner charged to a reverse polarity causes gradual increase of soiling.

Comparison 2

Toner was manufactured in much the same way as Example 1 except that 1.5 weight parts of melamine abrasive M-300 was added to the developer main particles.

Using the thus obtained toner, an endurance printing test was conducted for an image forming apparatus in FIG. 1 by continuously printing a solid image (print duty is 100%) on A4 size print medium 22.

Soiling was prominent from first pages, and at around 30000 pages.

After the endurance printing test, a large amount of melamine abrasive that has come off the toner particles was observed at the backside of the developing blade 17.

The toner was observed under an electron microscope (SEM) at the beginning and at the end of the endurance printing test. A large amount of melamine abrasive was observed on the toner surface at the end of the endurance printing test. This may be due to the fact that a large amount of melamine was added to the developer main particles. In this comparison, soiling was prominent at the beginning of the endurance printing test. This appears to be due to the fact that an excess amount of melamine having a polarity of charge opposite to the developer main particles was added and therefore the toner cannot be sufficiently charged. The result of Comparison 1 suggests that there is an optimum range for addition of melamine abrasive.

Examples 6-10 and comparisons 3 and 4 will be described with reference to Table 2.

TABLE 2

| | melamine abrasive | soiling of surface of |
|---|---|---|
| | added (weight parts) | photoconductive drum |
| Example 6 | 0.02 | fair |
| Example 7 | 0.05 | good |
| Example 8 | 0.50 | good |
| Example 9 | 1.00 | good |
| Example 10 | 1.20 | fair |
| Comparison 3 | 0 | poor |
| Comparison 4 | 1.50 | poor |

### Example 6

Toner was manufactured in the same way as Example 1. Using the thus obtained toner, an endurance printing test was conducted for an image forming apparatus in FIG. 3 by continuously printing a solid image (print duty is 100%) on A4 size print medium 22.

For a continuous print job of 50000 pages, the initial image quality was substantially maintained throughout 50000 pages but some soiling was observed on the print medium 22. Printing can be performed with sufficient density. No spent of the toner to the carrier occurred nor did filming occur on the surface of the respective charged members. No abnormality was observed in the print quality.

### Example 7

Toner was manufactured in much the same way as Example 6 except that 0. 05 weight parts of melamine abrasive M-300 was added to the developer main particles.

Using the thus obtained toner, an endurance printing test was conducted for an image forming apparatus in FIG. 3 by continuously printing a solid image (print duty is 100%) on A4 size print medium 22.

For a continuous print job of 50000 pages, the initial image quality was substantially maintained throughout 50000 pages. No soiling appeared on the print medium 22. Printing was performed with a sufficient density. No spent of the toner to the carrier occurred nor did filming occur on the surface of the respective charged members. No abnormality was observed in the print quality.

### Example 8

Toner was manufactured in much the same way as Example 6 except that 0.50 weight parts of melamine abrasive M-300 was not added to the developer main particles.

Using the thus obtained toner, an endurance printing test was conducted for an image forming apparatus in FIG. 3 by continuously printing a solid image (print duty is 100%) on A4 size print medium 22.

For a continuous print job of 50000 pages, the initial image quality was substantially maintained throughout 50000 pages. No soiling appeared on the print medium 22. Printing was performed with a sufficient density. No spent of the toner to the carrier occurred nor did filming occur on the surface of the respective charged members. No abnormality was observed in the print quality.

Then, the developing unit was disassembled and a surface area of the developing blade 17 in contact with the developing roller 14 was observed under an electron microscope (SEM). A large number of particles larger than silica having an average diameter of about 300 nm were observed. Infrared absorption spectrometry showed a peak value that implies the presence of melamine.

Likewise, the surfaces of the developing roller 14, toner supplying roller 15, and developing blade 17 were observed under an electron microscope (SEM) and the presence of the melamine abrasive was observed. This reveals that part of the melamine abrasive came off the toner particles and was deposited on the carrier to serve a supplemental role of the carrier. After the endurance printing test, the amount of charge of the toner on the carrier was measured with analyzer E-SPART available from HOSOKAWAMICRON CORPORATION. An average amount of charge was −40 μC/g, a minimum amount of charge was −51 μC/g, and a maximum amount of charge was −33 μC/g.

### Example 9

Toner was manufactured in much the same way as Example 6 except that 1.00 weight parts of melamine abrasive M-300 was added to the developer main particles.

Using the thus obtained toner, an endurance printing test was conducted for an image forming apparatus in FIG. 3 by continuously printing a solid image (print duty is 100%) on A4 size print medium 22.

For a continuous print job of 50000 pages, the initial image quality was substantially maintained throughout 50000 pages. No soiling appeared on the print medium 22. Printing was performed with a sufficient density. No spent of the toner to the carrier occurred nor did filming occur on the surface of the respective charged members. No abnormality was observed in the print quality.

### Example 10

Toner was manufactured in much the same way as Example 6 except that 1.20 weight parts of melamine abrasive M-300 was added to the developer main particles.

Using the thus obtained toner, an endurance printing test was conducted for an image forming apparatus in FIG. 3 by continuously printing a solid image (print duty is 100%) on A4 size print medium 22.

For a continuous print job of 50000 pages, the initial image quality was substantially maintained throughout 50000 pages. Some soiling appeared on the print medium 22. Printing was performed with a sufficient density. No spent of the toner to the carrier occurred nor did filming occur on the surface of the respective charged members. No abnormality was observed in the print quality.

Comparison 3

Toner was manufactured in much the same way as Example 6 except that no melamine abrasive M-300 was added to the developer main particles.

Using the thus obtained toner, an endurance printing test was conducted for an image forming apparatus in FIG. 3 by continuously printing a solid image (print duty is 100%) on A4 size print medium 22.

For first pages, printing can be performed with excellent print quality and good print quality was maintained until 5000 pages have been printed. After printing 5000 pages, the soiling on the print medium began to be noticeable. After printing 30000 pages, the soiling of the print medium became considerably prominent.

Then, the developing unit was disassembled and a surface area of the developing blade 17 in contact with the developing roller 14 was observed under an electron microscope (SEM). Extremely thin filming was observed. Infrared absorption spectrometry showed CH stretching vibration that indicates the presence of toner near a wave number of 28000 cm⁻¹ and C═O stretching vibration that indicates the presence of toner near a wave number of 1720 cm⁻¹.

The reason why soiling increases gradually during an endurance printing test is that toner is deposited on the surfaces of the charged members to cause filming so that a phenomenon similar to the self charging due to friction between toner particles occurs.

After the endurance printing test, the amount of charge of the toner remaining on the developing roller 14 was measured with analyzer E-SPART available from HOSOKAWAMICRON CORPORATION. An average amount of charge was −10 μC/g, a minimum amount of charge was −15 μC/g, and a maximum amount of charge was +10 μC/g. This measurement of the amount of charge implies that the occurrence of reverse charged toner causes a gradual increase of soiling.

Using the thus obtained toner, an endurance printing test was conducted for an image forming apparatus in FIG. 3 by continuously printing a solid image (print duty is 100%) on A4 size print medium 22.

Soiling was prominent from first pages and throughout the printing of 30000 pages.

After the endurance printing test, a large amount of melamine abrasive that has come off the toner particles was observed at the backside of the developing blade 17. The toner was observed under an electron microscope at the beginning and at the end of the endurance printing test. A large amount of melamine abrasive was observed on the toner surface at the end of the endurance printing test. This may be due to the fact that a large amount of melamine abrasive was added to the developer main particles. In this comparison, soiling was prominent at the beginning of the endurance printing test. This appears to be due to the fact that an excess amount of melamine having a polarity of charge opposite to the developer main particles was added and therefore the toner cannot be sufficiently charged. The result of Comparison 3 suggests that there is an optimum range for addition of melamine abrasive.

Examples 11-15 and comparisons 5 and 6 will be described with reference to Table 3.

TABLE 3

| | alumina added | soiling of surface of |
|---|---|---|
| | (weight parts) | photoconductive drum |
| Example 11 | 0.02 | fair |
| Example 12 | 0.05 | good |
| Example 13 | 0.50 | good |
| Example 14 | 1.00 | good |
| Example 15 | 1.20 | fair |
| Comparison 5 | 0 | poor |
| Comparison 6 | 1.50 | poor |

### Example 11

Toner was manufactured in much the same way as Example 1 except that alumina having an average particle diameter of 400 nm and an average charge of +30 μC/g was used as an abrasive in place of melamine abrasive M-300 and 0.02 weight parts of this alumina was added to the developer main particles.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. Some soiling appeared on the print medium 22. Printing was performed with a sufficient density. No filming occurred on the surface of the charged members and no abnormality was observed in print result.

### Example 12

Toner was manufactured in much the same way as Example 11 except that 0.05 weight parts of alumina was added to the developer main particles.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. No soiling appeared on the print medium 22. Printing was performed with a sufficient density. No filming occurred on the surface of the charged members and no abnormality was observed in print result.

### Example 13

Toner was manufactured in much the same way as Example 11 except that 0.50 weight parts of alumina was added to the developer main particles.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. No soiling appeared on the print medium 22. Printing was performed with a sufficient density. No filming occurred on the surface of the charged members and no abnormality was observed in print result.

Then, the developing unit was disassembled and a surface area of the developing blade 17 in contact with the developing roller 14 was observed under an electron microscope (SEM). A large number of particles larger than silica having an average diameter of about 400 nm were observed. Infrared absorption spectrometry showed a peak value that implies the presence of melamine.

Likewise, the surfaces of the developing roller 14 and the toner-supplying roller 15 were observed under an electron microscope and the same alumina was observed on the surfaces. This reveals that part of the melamine abrasive came off the toner particles and was deposited on the surfaces of the charged members. After the endurance printing test, the amount of charge of the toner on the developing roller 14 was measured with analyzer E-SPART available from HOSOKAWAMICRON CORPORATION. An average amount of charge was −35 μC/g, a minimum amount of charge was −45 μC/g, and a maximum amount of charge was −27 μC/g.

### Example 14

Toner was manufactured in much the same way as Example 11 except that 1.00 weight parts of alumina was added to the developer main particles.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. No soiling appeared on the print medium 22. Printing was performed with a sufficient density. No filming occurred on the surface of the charged members and no abnormality was observed in print result.

### Example 15

Toner was manufactured in much the same way as Example 11 except that 1.20 weight parts of alumina was added to the developer main particles.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. Some soiling appeared on the print medium 22. Printing was performed with a sufficient density. No filming occurred on the surface of the charged members and no abnormality was observed in print result.

Comparison 5

Toner was manufactured in much the same way as Example 11 except that no alumina was added to the developer main particles.

Using the thus obtained toner, an endurance printing test was conducted for an image forming apparatus in FIG. 1 by continuously printing a solid image (print duty is 100%) on A4 size print medium 22.

For first pages, printing can be performed with excellent print quality and good print quality was maintained until 5000 pages have been printed. After printing 5000 pages, the soiling on the print medium began to be noticeable. After printing 30000 pages, the soiling of the print medium became considerably prominent.

Comparison 6

Toner was manufactured in much the same way as Example 11 except that 1.50 weight parts of alumina was added to the developer main particles.

Using the thus obtained toner, an endurance printing test was conducted for an image forming apparatus in FIG. 1 by continuously printing a solid image (print duty is 100%) on A4 size print medium 22.

Soiling was prominent from first pages and around 30000 pages.

At the end of the endurance printing test, a large amount of alumina which has come off the toner was observed at the backside of the developing blade 17. The toner was observed under an electron microscope at the beginning of the endurance printing test and at the end of the endurance printing test. A large amount of alumina was observed on the toner surface at the end of the endurance printing test. This may be due to the fact that a large amount of alumina charged to a polarity opposite to the developer main particles was added to the developer main particles and therefore the toner cannot be charged sufficiently. The result of Comparison 1 suggests that there is an optimum range for an amount of alumina to be added.

Examples 16-20 and comparisons 7 and 8 will be described with reference to Table 4.

TABLE 4

| | alumina added | soiling of surface of |
|---|---|---|
| | (weight parts) | photoconductive drum |
| Example 16 | 0.02 | fair |
| Example 17 | 0.05 | good |
| Example 18 | 0.50 | good |
| Example 19 | 1.00 | good |
| Example 20 | 1.20 | fair |
| Comparison 7 | 0 | poor |
| Comparison 8 | 1.50 | poor |

### Example 16

Toner was manufactured by adding silicone abrasive in place of melamine abrasive M-300. The silicone abrasive has an average diameter of 500 nm and an average amount of charge of −600 μC/g. The silicone abrasive added was 0.02 weight parts. The other conditions were the same as in Example 1.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. However, some soiling appeared on the print medium 22. Printing was performed with a sufficient density. No filming occurred on the surface of the charged members and no abnormality was observed in print result.

### Example 17

Toner was manufactured in much the same way as Example 16 except that 0.05 weight parts of silicone abrasive was added.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. No soiling appeared on the print medium 22. Printing was performed with a sufficient density. No filming occurred on the surface of the charged members and no abnormality was observed in print result.

### Example 18

Toner was manufactured in much the same way as Example 16 except that 0.50 weight parts of silicone abrasive was added.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. No soiling appeared on the print medium 22. Printing was performed with a sufficient density. No filming occurred on the surface of the charged members and no abnormality was observed.

Then, the developing unit was disassembled and a surface area of the developing blade 17 in contact with the developing roller 14 was observed under an electron microscope (SEM). A large number of particles larger than silica having an average diameter of about 500 nm were observed. Infrared absorption spectrometry showed a peak value that implies the presence of silicone.

Likewise, the surfaces of the developing roller 14 and toner supplying roller 15 were observed under an electron microscope (SEM) and the presence of the silicone abrasive was observed. This reveals that during the endurance printing test, part of the silicone abrasive came off the toner particles and was deposited on the surfaces of the charge applying members. After the endurance printing test, the amount of charge of the toner on the developing roller 14 was measured with analyzer E-SPART available from HOSOKAWAMICRON CORPORATION. An average amount of charge was +25 μC/g, a minimum amount of charge was +15 μC/g, and a maximum amount of charge was +40 μC/g.

### Example 19

Toner was manufactured in much the same way as Example 16 except that 1.00 weight parts of silicone abrasive was added.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. No soiling appeared on the print medium 22. Printing was performed with a sufficient density. No filming occurred on the surface of the charged members and no abnormality was observed in print result.

### Example 20

Toner was manufactured in much the same way as Example 16 except that 1.20 weight parts of silicone abrasive was added.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. Some soiling appeared on the print medium 22. Printing was performed with a sufficient density. No filming occurred on the surface of the charged members and no abnormality was observed in print result.

Comparison 7

Toner was manufactured in much the same way as Example 16 except that no silicone abrasive was added.

Using the thus obtained toner, an endurance printing test was conducted for an image forming apparatus in FIG. 1 by continuously printing a solid image (print duty is 100%) on A4 size print medium 22.

For a continuous print job, soiling appeared on initial pages of the print medium 22, and became very prominent after 500 pages and therefore printing was stopped.

Comparison 8

Toner was manufactured in much the same way as Example 16 except that 1.50 weight parts of silicone abrasive was added.

Using the thus obtained toner, an endurance printing test was conducted for an image forming apparatus in FIG. 1 by continuously printing a solid image (print duty is 100%) on A4 size print medium 22.

For a continuous print job, soiling appeared on initial pages of the print medium 22, and became very prominent after 500 pages and therefore printing was stopped.

Then, the developing unit was disassembled and a surface area of the developing blade 17 in contact with the developing roller 14 was observed under an electron microscope (SEM). A large number of particles larger than silica having an average diameter of about 500 nm were observed. Infrared absorption spectrometry showed a peak value that implies the presence of silicone.

Likewise, the surfaces of the developing roller 14 and toner supplying roller 15 were observed under an electron microscope (SEM) and the presence of the silicone abrasive was observed. This reveals that during the endurance printing test, part of the silicone abrasive came off the toner particles and was deposited on the surfaces of the charge applying members.

After the endurance printing test, the amount of charge of the toner remaining on the developing roller 14 was measured with analyzer E-SPART available from HOSOKAWAMICRON CORPORATION. An average amount of charge was −25 μC/g, a minimum amount of charge was −35 μC/g, and a maximum amount of charge was +15 μC/g.

This appears to be due to the fact that the silicone abrasive comes off the developer main particles and clings to the charge applying members to cause part of the toner to be charged to a reverse polarity (positive), resulting in soiling on the medium 22.

Examples 21-27 and comparisons 9 and 10 will be described with reference to Table 5.

TABLE 5

| | diameter of | | |
|---|---|---|---|
| | abrasive (nm) | soiling | blur |
| Example 21 | 50 | fair | good |
| Example 22 | 150 | good | good |
| Example 23 | 300 | good | good |
| Example 24 | 400 | good | good |
| Example 25 | 500 | good | good |
| Example 26 | 1000 | good | good |
| Example 27 | 5000 | good | fair |
| Comparison 9 | 12 | poor | good |
| Comparison 10 | 6500 | good | poor |

### Example 21

Toner was manufactured in much the same way as Example 3 except that melamine abrasive M-50 having an average diameter of 50 nm, and an average amount of charge of +1100 μC/g was used in place of melamine abrasive M-300.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. Some soiling appeared on the print medium 22. Noblur of image was observed. Printing was performed with a sufficient density. No filming occurred on the surface of the charged members and no abnormality was observed in print result.

Then, the developing unit was disassembled, and a surface area of the developing blade 17 in contact with the developing roller 14 was observed under an electron microscope (SEM). A large number of particles larger than silica having an average diameter of about 50 nm were observed. Infrared absorption spectrometry showed a peak value that implies the presence of melamine.

Likewise, the surfaces of the developing roller 14 and toner supplying roller 15 were observed under an electron microscope (SEM) and the presence of the melamine abrasive was observed. This reveals that during the endurance printing test, part of the melamine abrasive came off the toner particles and was deposited on the surfaces of the charge applying members.

### Example 22

Toner was manufactured in much the same way as Example 21 except that melamine abrasive M-150 having an average diameter of 150 nm, and an average amount of charge of +800 μC/g was used in place of melamine abrasive M-50.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. Some soiling appeared on the print medium 22. No blur of image was observed. Printing was performed with a sufficient density. No filming occurred on the surface of the charged members and no abnormality was observed in print result.

Then, the developing unit was disassembled, and a surface area of the developing blade 17 in contact with the developing roller 14 was observed under an electron microscope (SEM). A large number of particles larger than silica having an average diameter of about 150 nm were observed. Infrared absorption spectrometry showed a peak value that implies the presence of melamine.

Likewise, the surfaces of the developing roller 14 and toner supplying roller 15 were observed under an electron microscope (SEM) and the presence of the melamine abrasive was observed. This reveals that during the endurance printing test, part of the melamine abrasive came off the toner particles and was deposited on the surfaces of the charge applying members.

### Example 23

Toner was manufactured in much the same way as Example 3 except that melamine abrasive M-300 having an average diameter of 300 nm, and an average amount of charge of +600 μC/g was used in place of melamine abrasive M-50.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. No soiling appeared on the print medium 22. No blur of image was observed. Printing was performed with a sufficient density. No filming occurred on the surface of the charged members and no abnormality was observed in print result.

Then, the developing unit was disassembled, and a surface area of the developing blade 17 in contact with the developing roller 14 was observed under an electron microscope (SEM). A large number of particles larger than silica having an average diameter of about 300 nm were observed. Infrared absorption spectrometry showed a peak value that implies the presence of melamine.

Likewise, the surfaces of the developing roller 14 and toner supplying roller 15 were observed under an electron microscope (SEM) and the presence of the melamine abrasive was observed. This reveals that during the endurance printing test, part of the melamine abrasive came off the toner particles and was deposited on the surfaces of the charge applying members.

### Example 24

Toner was manufactured in much the same way as Example 13 except that alumina having an average diameter of 400 nm, and an average amount of charge of +30 μC/g was used in place of melamine abrasive M-50, and 0.02 weight parts of this alumina was added.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. No soiling appeared on the print medium 22. No blur of image was observed. Printing was performed with a sufficient density. No filming occurred on the surface of the charged members and no abnormality was observed in print result.

Then, the developing unit was disassembled, and a surface area of the developing blade 17 in contact with the developing roller 14 was observed under an electron microscope (SEM). A large number of particles larger than silica having an average diameter of about 400 nm were observed. Infrared absorption spectrometry showed a peak value that implies the presence of alumina.

Likewise, the surfaces of the developing roller 14 and toner supplying roller 15 were observed under an electron microscope (SEM) and the presence of alumina was observed. This reveals that during the endurance printing test, part of alumina came off the toner particles and was deposited on the-surfaces of the charge applying members.

### Example 25

Toner was manufactured in much the same way as Example 18 except that silicone abrasive having an average diameter of 500 nm, and an average amount of charge of −600 μC/g was used in place of melamine abrasive M-50, and 0.02 weight parts of this silicone abrasive was added.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. No soiling appeared on the print medium 22. No blur of image was observed. Printing was performed with a sufficient density. No filming occurred on the surface of the charged members and no abnormality was observed in print result.

Then, the developing unit was disassembled, and a surface area of the developing blade 17 in contact with the developing roller 14 was observed under an electron microscope (SEM). A large number of particles larger than silica having an average diameter of about 500 nm were observed. Infrared absorption spectrometry showed a peak value that implies the presence of silicone.

Likewise, the surfaces of the developing roller 14 and toner supplying roller 15 were observed under an electron microscope (SEM) and the presence of silicone was observed. This reveals that during the endurance printing test, part of silicone abrasive came off the toner particles and was deposited on the surfaces of the charge applying members.

### Example 26

Toner according to Example 26 was manufactured in much the same way as Example 21 except that melamine abrasive M-1000 having an average diameter of 1000 nm, and an average amount of charge of +150 μC/g was used in place of melamine abrasive M-50.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. No soiling appeared on the print medium 22. No blur of image was observed. Printing was performed with a sufficient density. No filming occurred on the surface of the charged members and no abnormality was observed in print result.

Then, the developing unit was disassembled, and a surface area of the developing blade 17 in contact with the developing roller 14 was observed under an electron microscope (SEM). A large number of particles larger than silica having an average diameter of about 1000 nm were observed. Infrared absorption spectrometry showed a peak value that implies the presence of melamine.

Likewise, the surfaces of the developing roller 14 and toner supplying roller 15 were observed under an electron microscope (SEM) and the presence of melamine abrasive was observed. This reveals that part of melamine abrasive came off the toner particles and was deposited on the surfaces of the charge-applying members.

### Example 27

Toner according to Example 27 was manufactured in much the same way as Example 21 except that alumina having an average diameter of 5000 nm, and an average amount of charge of +12 μC/g was used in place of melamine abrasive M-50, and 0.50 weight parts of this alumina was added.

Using the thus obtained toner, an endurance printing test was conducted for an image forming apparatus in FIG. 1 by continuously printing a solid image (print duty is 100%) on A4 size print medium 22.

For a continuous print job of 50000 pages, the initial image quality was substantially maintained throughout 50000 pages. No soiling appeared on the print medium 22. The fluidity of toner is slightly low and therefore some blur of image was observed. Printing was performed with a sufficient density. No filming occurred on the surface of the charge applying members and no abnormality was observed in print result.

Then, the developing unit was disassembled, and a surface area of the developing blade 17 in contact with the developing roller 14 was observed under an electron microscope (SEM). A large number of particles larger than silica having an average diameter of about 5000 nm were observed. Infrared absorption spectrometry showed a peak value that implies the presence of alumina.

Likewise, the surfaces of the developing roller 14 and toner supplying roller 15 were observed under an electron microscope (SEM) and the presence of alumina was observed. This reveals that during the endurance printing test, part of alumina came off the toner particles and was deposited on the surfaces of the charge applying members.

Comparison 9

Toner according to comparison 9 was manufactured in much the same way as Example 21 except that silica RA200H (Aerosil Japan) having an average diameter of 12 nm, and an average amount of charge of +450 μC/g was used in place of melamine abrasive M-50, and 0.50 weight parts of this silica was added.

Using the thus obtained toner, an endurance printing test was conducted for an image forming apparatus in FIG. 1 by continuously printing a solid image (print duty is 100%) on A4 size print medium 22.

For a continuous print job, soiling appeared on initial pages of the print medium 22, and became very prominent after 500 pages and therefore printing was stopped.

Then, the developing unit was disassembled, and air was blown against the toner deposited on the surface of the developing blade 17 in contact with the surface area of the developing blade 17 that contacts the developing roller 14. Then, the surface was observed under an electron microscope (SEM) but nothing was observed.

After the endurance printing test, the amount of charge of the toner deposited on the developing roller 14 was measured with analyzer E-SPART available from HOSOKAWAMICRON CORPORATION. An average amount of charge was −10° C./g, a minimum amount of charge was −15μC/g, and a maximum amount of charge was +25 μC/g.

Because silica having an average diameter of 12 nm and a positive polarity of charge is added, the amount of charge of toner is much lower than that of the developer main particles and silica has firmly adhered to the developer main particles by the Van der Waals force. Moreover, it is considered that silica is charged to a polarity opposite to that of toner, and therefore soiling is prominent.

Comparison 10

Toner according to comparison 10 was manufactured in much the same way as Example 21 except that alumina having an average diameter of 6500 nm, and an average amount of charge of +10 μC/g was used in place of melamine abrasive M-50, and 0.50 weight parts of alumina was added.

Using the thus obtained toner, an endurance printing test was conducted for an image forming apparatus in FIG. 1 by continuously printing a solid image (print duty is 100%) on A4 size print medium 22.

The fluidity of toner is slightly low and therefore some blur of image was observed in initial pages. For a continuous print job of 50000 pages, the initial image quality was substantially maintained throughout 50000 pages. No soiling appeared on the print medium 22 but print density was lower than that for initial pages and blur became detectable at the end of 50000 pages.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. A developer comprising:
developer main particles including at least a resin material and a coloring material; and
abrasive particles added to said developer main particles;
wherein said abrasive particles and said developer main particles are opposite in polarity to which said abrasive particles and said developer main particles are charged.

2. The developer according to claim 1, wherein said abrasive particles have an average diameter in the range of 50 to 5000 nm.

3. The developer according to claim 2, wherein the average diameter of said abrasive particles is preferably in the range of 150 to 2000 nm.

4. The developer according to claim 1, wherein a fluidity-adding agent is added to said developer main particles.

5. The developer according to claim 1, wherein the fluidity-adding agent is one of a plurality of fluidity-adding agents, and has a diameter in the range of 5 to 40 nm.

6. The developer according to claim 1, wherein said developer main particles are charged to a first polarity when said developer main particles are subjected to frictional contact with iron powder,
wherein said abrasives particles are charged to a second polarity opposite to the first polarity when said abrasive particles are subjected to frictional contact with iron powder.

7. The developer according to claim 4, wherein the fluidity-adding agent is at least 0.1 weight parts with respect to said developer main particles, and said abrasive particles are in the range of 0.02 to 1.2 weight parts.

8. The developer according to claim 7, wherein said abrasive particles are preferably in the range of 0.05 to 1.0 weight parts.

9. A developer cartridge that holds a developer, wherein the developer comprises:
developer main particles including at least a resin material and a coloring material; and
abrasive particles added to said developer main particles;
wherein said abrasive particles and said developer main particles are opposite in polarity to which they are charged.

10. The developer according to claim 9, wherein said developer main particles are charged to a first polarity when said developer main particles are subjected to frictional contact with iron powder, wherein said abrasives particles are charged to a second polarity opposite to the first polarity when said abrasive particles are subjected to frictional contact with iron powder.

11. An image forming apparatus comprising:
a developer cartridge that holds a developer therein;
an image bearing body;
a charging unit that charges a surface of said image bearing body;
an exposing unit that illuminates the surface of said image bearing body charged by said charging unit to form an electrostatic latent image; and
a developing unit that develops the electrostatic latent image with a developer supplied from said developer cartridge into a visible image;
wherein the developer includes a developer main particles including at least a resin material and a coloring material, and abrasive particles added to said developer main particles, wherein said abrasive and said developer main particles are opposite in polarity to which they are charged.

12. The developer according to claim 11, wherein said developer main particles are charged to a first polarity when said developer main particles are subjected to frictional contact with iron powder,
wherein said abrasives particles are charged to a second polarity opposite to the first polarity when said abrasive particles are subjected to frictional contact with iron powder.
